(19) United States
(12) Patent Application Publication
(10) Pub. No.: US 2012/0313470 A1
(43) Pub. Date: Dec. 13, 2012

(54) Motor

(75) Inventors: Ta Kyoung Lee, Hwaseong (KR); Bum Cho Kim, Seoul (KR); Hyuk Joo Kim, Seoul (KR); Sang Jin Park, Hwaseong (KR); Jee Ae Noh, Seoul (KR)

(73) Assignee: SAMSUNG ELECTRO-MECHANICS CO., LTD, Suwon (KR)

(21) Appl. No.: 13/200,828

(22) Filed: Oct. 3, 2011

(30) Foreign Application Priority Data
Jun. 8, 2011 (KR) 10-2011-0055172

(51) Int. Cl. H02K 7/08

(52) U.S. Cl. 310/90

(57) ABSTRACT

There is provided a motor including: a sleeve supporting a shaft and a thrust plate coupled to the shaft through oil; a hub operating together with the shaft and including a magnet coupled thereto; a base including the sleeve and a core coupled thereto, the core including a coil wound therearound; and a base cover coupled to the sleeve to thereby close a lower portion of the sleeve, wherein an interval between the sleeve and the hub is smaller than an interval between the thrust plate and the base cover in order to maintain a state of non-contact between the thrust plate and the base cover.

### CROSS-REFERENCE TO RELATED APPLICATIONS

This application claims the priority of Korean Patent Application No. 10-2011-0055172 filed on Jun. 8, 2011, in the Korean Intellectual Property Office, the disclosure of which is incorporated herein by reference.

### BACKGROUND OF THE INVENTION

1. Field of the Invention

The present invention relates to a motor, and more particularly, to a motor capable of being used in a hard disk drive (HDD) rotating a recording disk.

2. Description of the Related Art

A hard disk drive (HDD), an information storage device, reads data stored on a disk or writes data to a disk using a read/write head.

The hard disk drive requires a disk driving device capable of driving the disk. As the disk driving device, a spindle motor is used.

In the spindle motor, a fluid dynamic pressure bearing assembly has been used. A shaft, a rotating member of the fluid dynamic pressure bearing assembly, and a sleeve, a fixed member thereof, include oil interposed therebetween, such that the shaft is supported by fluid pressure generated by the oil.

Here, the demand for a spindle motor having high capacity and a thin thickness has been continuously increased. In accordance with the trend for the thinning and miniaturization of the motor, the strength of a bearing has naturally been reduced.

The strength of the bearing, which is an important factor determining rotational characteristics of the spindle motor, is influenced by an interval between dynamic grooves, that is, a bearing span length.

That is, as the bearing span length is enlarged, the strength of the bearing increases, such that the rotational characteristics of the motor may be improved. Therefore, even in the case that the motor has high capacity and a thin thickness, the strength of the bearing should not be influenced.

In addition, when the spindle motor according to the related art suffers an external impact applied thereto, contact between components may be generated, such that the components may be damaged.

Therefore, research into a technology for allowing a spindle motor to have high capacity and a thin thickness without having an influence on the strength of a bearing to prevent damage to the spindle motor, even in a case in which an external impact, or the like, is applied thereto, whereby the performance and lifespan of the spindle motor may be maximized has been urgently required.

### SUMMARY OF THE INVENTION

An aspect of the present invention provides a motor preventing damage to components thereof due to an external impact, or the like, and improving strength of a bearing to thereby maximize rotational characteristics thereof.

According to an aspect of the present invention, there is provided a motor including: a sleeve supporting a shaft and a thrust plate coupled to the shaft through oil; a hub operating together with the shaft and including a magnet coupled thereto; a base including the sleeve and a core coupled thereto, the core including a coil wound therearound; and a base cover coupled to the sleeve to thereby close a lower portion of the sleeve, wherein an interval between the sleeve and the hub is smaller than an interval between the thrust plate and the base cover in order to maintain a state of non-contact between the thrust plate and the base cover.

The shaft and the hub may rotate while being floated by the oil flowing between the thrust plate and the base cover.

Pressure acting on a lower surface of the thrust plate may be smaller than pressure acting on an upper surface thereof due to the oil.

At least one of the upper surface of the thrust plate and a surface of the sleeve corresponding to the upper surface of the thrust plate may be provided with a thrust dynamic pressure part providing thrust dynamic pressure for preventing the shaft and the hub from being excessively floated.

The shaft and the thrust plate may be formed integrally with each other.

An upper surface of the sleeve and the hub may include an oil sealing part provided therebetween, the oil sealing part forming an interface of the oil.

At least one of an upper surface of the sleeve and a surface of the hub facing the upper surface of the sleeve may be provided with a pumping part pumping the oil between the shaft and the sleeve.

An interval between an upper surface of the sleeve and the hub may increase in an outer diameter direction.

The upper surface of the sleeve may be inclined downwardly in the outer diameter direction.

A surface of the hub facing the upper surface of the sleeve may be inclined upwardly in the outer diameter direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor according to an embodiment of the present invention;

FIG. 2 is a schematic cut-away perspective view showing a sleeve included in a motor according to an embodiment of the present invention;

FIG. 3 is a schematic cross-sectional view showing a sleeve included in a motor according to an embodiment of the present invention;

FIG. 4 is a schematic cut-away perspective view showing a hub included in a motor according to an embodiment of the present invention;

FIG. 5 is a schematic partial cross-sectional view describing a principle that a motor according to an embodiment of the present invention is floated and rotated; and

FIG. 6 is a schematic partial cross-sectional view describing a state in which a thrust plate and a base cover included in a motor according to an embodiment of the present invention do not contact each other.

### DETAILED DESCRIPTION OF THE PREFERRED EMBODIMENT

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

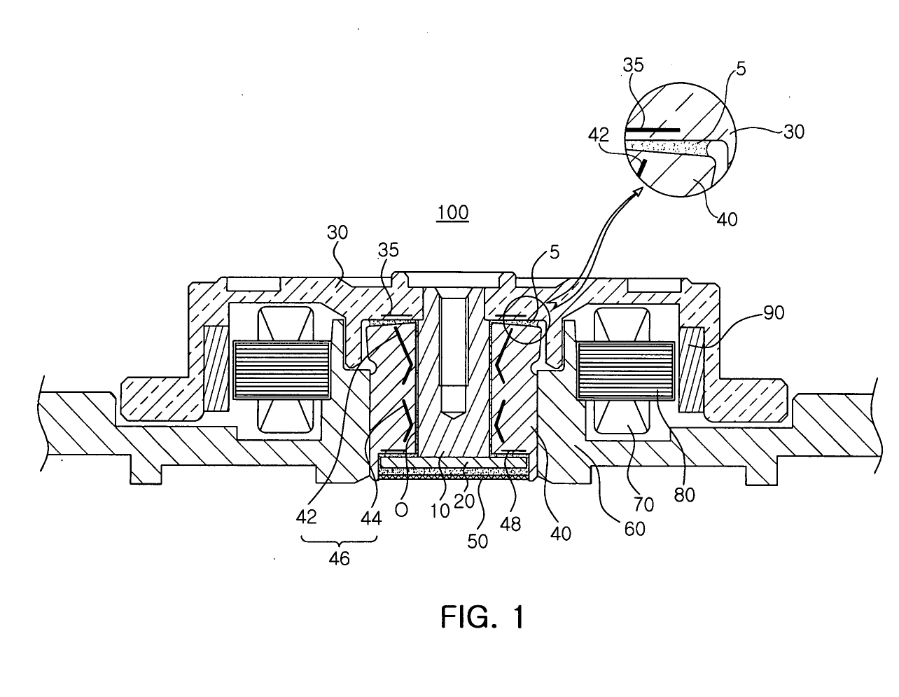

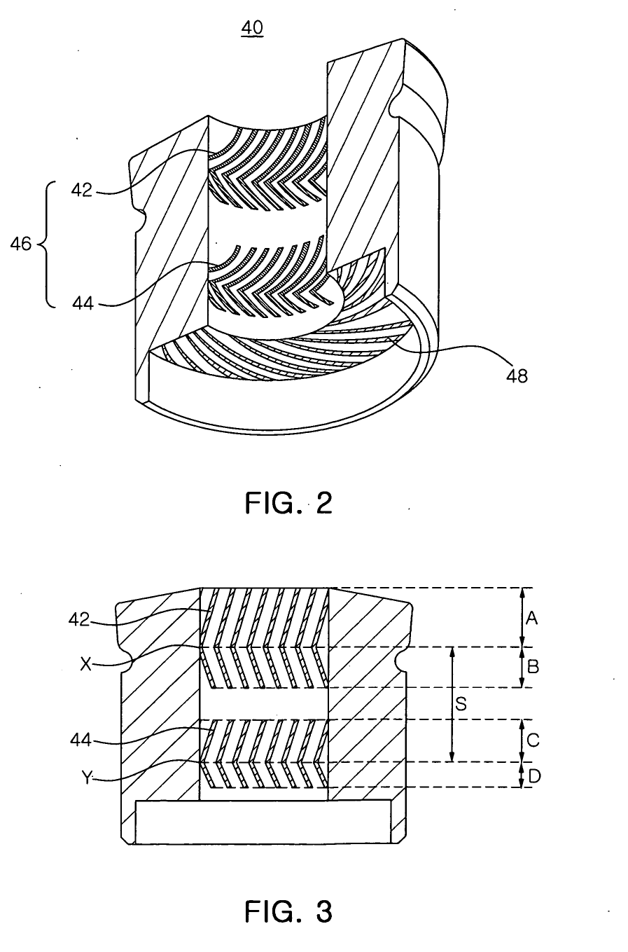

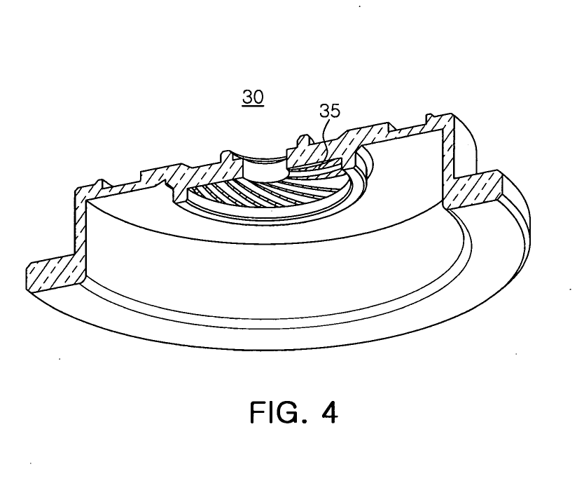

FIG. 1 is a schematic cross-sectional view showing a motor according to an embodiment of the present invention; FIG. 2 is a schematic cut-away perspective view showing a sleeve included in a motor according to an embodiment of the present invention; FIG. 3 is a schematic cross-sectional view showing a sleeve included in a motor according to an embodiment of the present invention; and FIG. 4 is a schematic cut-away perspective view showing a hub included in a motor according to an embodiment of the present invention.

Referring to FIGS. 1 through 4, a motor 100 according to an embodiment of the present invention may include a rotating member and a stationary member supporting rotation of the rotating member.

More specifically, the rotating member may include a shaft 10, a thrust plate 20, and a hub 30, and the stationary member may include a sleeve 40, a base cover 50, and a base 60.

Terms with respect to directions will be first defined. As viewed in FIG. 1, an axial direction refers to a vertical direction based on the shaft 10, and an outer diameter or inner diameter direction refers to a direction towards an outer edge of the hub 30 based on the shaft 10 or a direction towards the center of the shaft 10 based on the outer edge of the hub 30.

The shaft 10, which is one of the rotating members, may be inserted into a shaft hole of the sleeve 40 so as to have a small clearance between the shaft 10 and the sleeve 40, to thereby rotate in the sleeve 40, and may include the hub 30 coupled to an upper portion thereof.

In addition, the shaft 10 may include the thrust plate 20 coupled to a lower portion thereof, the thrust plate 20 providing thrust dynamic pressure. The shaft 10 and the hub 30 may float and rotate by the thrust plate 20.

That is, pressure generated by oil O may exist on upper and lower surfaces of the thrust plate 20, and the shaft 10 and the hub 30 may be floated by the pressure.

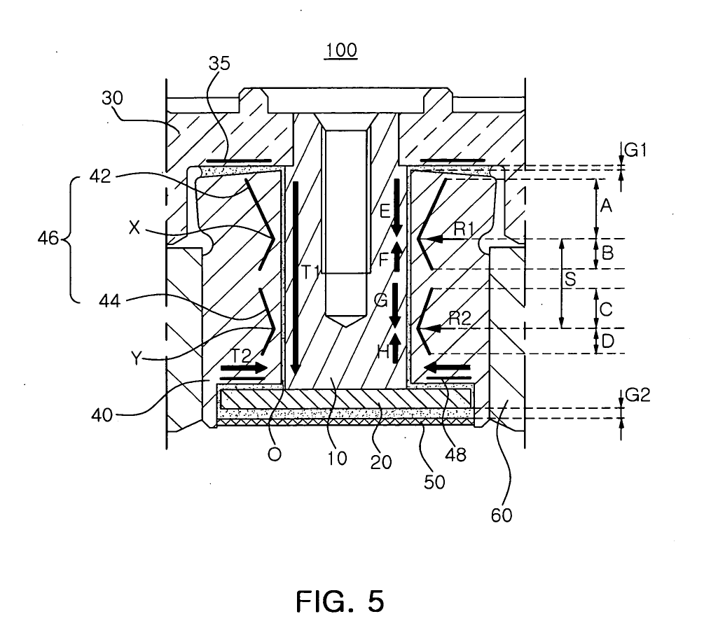

A detailed description thereof will be provided below with reference to FIG. 5.

Here, the thrust plate 20 may be coupled to the shaft 10 through bonding, welding, press-fitting, or the like, by an adhesive or be formed integrally with the shaft 10 rather than being formed as a member separated from the shaft 10.

The hub 30, which is a rotating member coupled to the upper portion of the shaft 10 to rotate together with the shaft 10, may include an annular ring shaped magnet 90 formed on an inner peripheral surface thereof, the annular ring shaped magnet 90 facing a core 80 including a coil 70 wound therearound while having a predetermined interval therebetween.

In addition, the hub 30 may include a pumping part 35 formed in an inner surface thereof, that is, one surface thereof facing an upper surface of the sleeve 40.

The pumping part 35, a component preventing leakage of the oil O filled between the upper surface of the sleeve 40 and the hub 30, may pump the oil O between the shaft 10 and the sleeve 40 at the time of rotation of the motor 100 according to the embodiment of the present invention.

Therefore, at the time of the rotation of the motor 100 according to the embodiment of the present invention, the leakage of the oil O due to external impacts, or the like, may be prevented, such that an appropriate amount of oil O may be maintained. Accordingly, dynamic pressure is maintained by the oil O, whereby strength of the bearing may be improved.

Here, the pumping pat 35 may be a groove having a spiral shape as shown in FIG. 4. However, pumping part 35 is not limited thereto, but may have a herringbone shape or a screw shape.

The sleeve 40, which is one of stationary members, may support the shaft 10 such that an upper end of the shaft 10 protrudes upwardly in the axial direction and also simultaneously support the thrust plate 20 coupled to the shaft 10.

That is, the sleeve 40 may support the shaft 10 and the thrust plate 20 through the oil O.

Here, the sleeve 40 may be formed by forging Cu or Al or sintering a Cu—Fe-based alloy powder or a SUS-based powder.

The sleeve 40 may include a radial dynamic pressure part 46 formed in an inner peripheral surface thereof, and radial dynamic pressure due to the radial dynamic pressure part 46 may smoothly support the rotation of the shaft 10.

More specifically, the radial dynamic pressure part 46 may include an upper radial dynamic pressure part 42 formed at an upper portion of the sleeve 40 and a lower radial dynamic pressure part 44 formed at a lower portion of the sleeve 40.

That is, the upper and lower radial dynamic pressure parts 42 and 44 may be formed to be spaced apart from each other.

In addition, the upper and lower radial dynamic pressure parts 42 and 44 may be grooves having a herringbone shape as shown in FIGS. 2 and 3. Lengths of the grooves may be asymmetrical based on bent points X and Y.

More specifically, defining the lengths of the grooves as A, B, C, and D, respectively, based on the bent points X and Y of the upper and lower radial dynamic pressure parts 42 and 44, the lengths of the grooves may satisfy the following conditional expression.

A+C>B+D [Conditional Expression]

Therefore, due to the configuration of the upper and lower radial dynamic pressure parts 42 and 44 satisfying the above conditional expression, at the time of rotation of the shaft 10 and the hub 30, in addition to the radial dynamic pressures directed in the inner diameter direction, pressure directed downwardly in the axial direction due to the oil O may be generated.

In addition, the pressure directed downwardly in the axial direction as described above generates floating force at the time of the rotation of the shaft 10 and the hub 30, which will be described below with reference to FIG. 5.

Here, the radial dynamic pressure part 46 is not limited to being formed in the inner peripheral surface of the sleeve 40 as shown in FIGS. 2 and 3 but may also be formed in an outer peripheral surface of the shaft 10 facing the inner peripheral surface of the sleeve 40.

In addition, the sleeve 40 may include a thrust dynamic pressure part 48 formed in a bottom surface thereof, the thrust dynamic pressure part 48 providing the thrust dynamic pressure so as to prevent the shaft 10 and the hub 30 from being excessively floated at the time of the rotation of the shaft 10 and the hub 30.

The thrust dynamic pressure part 48 may provide the thrust dynamic pressure directed downwardly in the axial direction so as to prevent the rotating member from being excessively floated due to the oil O flowing between the thrust plate 20 and a base cover 50 to be described below, which will be described below with reference to FIG. 5.

Here, the thrust dynamic pressure part 48 is not limited to being formed in the bottom surface of the sleeve 40 but may also be formed in the upper surface of the thrust plate 20 facing the bottom surface of the sleeve 40.

In addition, an interval between the upper surface of the sleeve 40 and the hub 30 facing the upper surface of the sleeve 40 may be increased in the outer diameter direction.

More specifically, the upper surface of the sleeve 40 may be inclined downwardly in the outer diameter direction, as shown in FIG. 1.

In addition, although not shown, one surface of the hub 30 facing the upper surface of the sleeve 40 may be inclined upwardly in the outer diameter direction, and both of the upper surface of the sleeve 40 and one surface of the hub 30 may be inclined.

This is to prevent leakage of the oil O using a capillary phenomenon of the oil O filled in the interval between the upper surface of the sleeve 40 and the hub 30 facing the upper surface of the sleeve 40, to thereby maximize sealing capability of the oil O simultaneously with securing a storage space of the oil O.

That is, the upper surface of the sleeve 40 and one surface of the hub 30 facing the upper surface of the sleeve 40 may include an interface of the oil O formed therebetween and an oil sealing part 5 provided therebetween, the oil sealing part 5 maintaining the interface of the oil O in a normal state.

The oil sealing part 5 may be formed by the upper surface of the sleeve 40 and one surface of the hub 30. More specifically, the oil sealing part 5 refers to an interval between the upper surface of the sleeve 40 and one surface of the hub 30.

In addition, the sleeve 40 may include the base cover 50 coupled to a lower portion thereof in the axial direction, the base cover 50 being coupled to the sleeve 40 while having a predetermined interval maintained therebetween, to thereby close the lower portion of the sleeve 40.

Here, the interval between the base cover 50 and the thrust plate 20 may be larger than the interval between the upper surface of the sleeve 40 and the hub 30.

Therefore, when the shaft 10 and the hub 30 move downwardly in the axial direction due to external impacts, or the like, the upper surface of the sleeve 40 and the hub 30 may be first in contact with each other, to thereby prevent the thrust plate 20 from coming into contact with the base cover 50.

Therefore, since the base cover 50 may be maintained in a state in which it does not contact the thrust plate 20 in spite of the external impacts, or the like, the base cover 50 needs not to have a thickness required for preventing damage thereof due to the contact.

That is, the base cover 50 having a small-sized thickness may be coupled to the sleeve 40 to thereby close the lower portion of the sleeve 40.

Therefore, in miniaturizing and thinning of the motor 100 according to the embodiment of the present invention, since the thickness of the base cover 50 may be relatively reduced, the entire height of the sleeve 40 may be maintained to be same as that of the case according to the related art or be increased as compared to the case according to the related art.

Therefore, since a distance between the bent points X and Y of the radial dynamic pressure part 46, that is, a bearing span length S may be increased, the entire strength of the bearing may be improved.

A detailed description thereof will be provided below with reference to FIG. 5.

Here, the oil O may be continuously filled in the clearance between the shaft 10 and the sleeve 40, in a clearance between the hub 30 and the sleeve 40, and in a clearance between the base cover 50 and the shaft 10, and the sleeve 40, whereby a full-fill structure may be entirely formed.

The base 60 may be a stationary member supporting the rotation of the rotating member including the shaft 10 and the hub 30 with respect to the rotating member.

Here, the base 60 may include the core 80 coupled thereto, the core 80 including the coil 70 wound therearound. The core 80 may be fixedly disposed on an upper portion of the base 60 including a printed circuit board (not shown) having pattern circuits printed thereon.

The base 60 may include the sleeve 40 and the core 80 inserted thereinto and coupled thereto, the core 80 including the coil 70 wound therearound.

Here, as a method of coupling the sleeve 40 and the core 80 to the base 60, a bonding method, a welding method, a press-fitting method, or the like, may be used. However, a method of coupling the sleeve 40 and the core 80 to the base 60 is not necessarily limited thereto.

Here, rotational driving force of the motor 100 according to the embodiment of the present invention may be obtained by electromagnetic interaction between the coil 70 wound around the core 80 and the magnet 90 coupled to the hub 30.

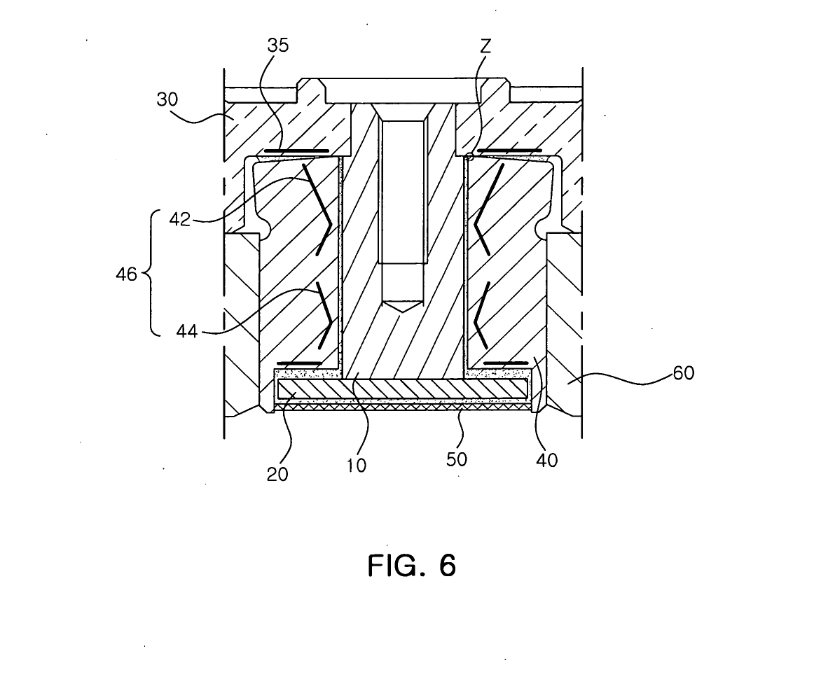

FIG. 5 is a schematic partial cross-sectional view describing the principle that a motor according to an embodiment of the present invention is floated and rotated; and FIG. 6 is a schematic partial cross-sectional view describing a state in which a thrust plate and a base cover included in a motor according to an embodiment of the present invention do not contact each other.

Referring to FIGS. 5 and 6, whether the rotating member including the shaft 10 and the hub 30 stops or rotates, an interval G1 between the upper surface of the sleeve 40 and the hub 30 in the motor 100 according to the embodiment of the present invention may be different from an interval G2 between the thrust plate 20 and the base cover 50.

That is, the interval G1 between the upper surface of the sleeve 40 and the hub 30 may be smaller than the interval G2 between the thrust plate 20 and the base cover 50.

Here, since the interval G1 between the upper surface of the sleeve 40 and the hub 30 may increase in the outer diameter direction, even though any point is selected in the outer diameter direction, the interval G2 between the thrust plate 20 and the base cover 50 may be formed to be larger than the interval G1 between the upper surface of the sleeve 40 and the hub 30 at the selected point.

However, the interval G2 between the base cover 50 and the thrust plate 20 may also be larger than an interval at an innermost point among intervals between the upper surface of the sleeve 40 and the hub 30 at several points in the outer diameter direction.

Owing to a difference between the intervals G1 and G2 as described above, when the shaft 10 and the hub 30, which are rotating members, move from their normal positions due to the external impacts, or the like, the upper surface of the sleeve 40 and the hub 30 may come in contact with each other (See Z of FIG. 6), whereby the thrust plate 20 and the base cover 50 may be maintained in a state in which they do not contact each other, as shown in FIG. 6.

In other words, when the rotating member moves downwardly in the axial direction due to the external impacts, or the like, the upper surface of the sleeve 40 may serve as a stopper preventing the movement of the rotating members, and the rotating members may move only until the upper surface of the sleeve 40 and the hub 30 comes into contact with each other (See Z of FIG. 6).

Here, the upper surface of the sleeve 40 may include a predetermined flat surface, in order to increase a contact area with the hub 30 in a relationship between the upper surface of the sleeve 40 and the hub 30 to thereby enhance a stopper function.

Therefore, even though the rotating member including the shaft 10 and the hub 30 has the external impacts, or the like, applied thereto, the rotating member may move by an amount equal to the interval G1 between the upper surface of the sleeve 40 and the hub 30. Since the interval G1 is smaller than the interval G2 between the base cover 50 and the thrust plate 20, the base cover 50 and the thrust plate 20 do not contact each other.

Therefore, as long as the base cover 50 may be designed only to close the lower portion of the sleeve 40 without considering defects such as damage due to the contact with the thrust plate 20, or the like, the performance of the motor 100 according to the embodiment of the present invention may be maintained. Therefore, the thickness of the base cover 50 may be relatively reduced.

Here, The fact that the thickness of the base cover 50 may be reduced by controlling the interval G1 between the upper surface of the sleeve 40 and the hub 30 and the interval G2 between the thrust plate 20 and the base cover 50 is closely associated with the thinning and the miniaturization of the motor 100 according to the embodiment of the present invention in view of another aspect.

That is, the miniaturization and the thinning of the motor may be implemented by reducing the entire height of the motor. In order to reduce the height, the entire height of a shaft system, that is, the shaft and the sleeve of the motor generally needs to be reduced.

However, when the entire height of the shaft and the sleeve is reduced for the miniaturization and the thinning of the motor, the bearing span length is shortened, such that the radial dynamic pressure for supporting the rotation of the shaft may become degraded.

Here, describing the bearing span length S based on the motor 100 according to the embodiment of the present invention, the bearing span length S refers to a distance between points X and Y at which pressures generated by the upper and lower radial dynamic pressure parts 42 and 44 are greatest. As the bearing span length is enlarged, the rotation of the shaft 10 may be stably supported.

In other words, the pressures generated toward the shaft 10 by the upper and lower radial dynamic pressure parts 42 and 44 are largest in predetermined points X and Y due to shapes of the upper and lower radial dynamic pressure parts 42 and 44 (See E, F, G, and H of FIG. 5). As the distance between the points X and Y supporting the shaft 10 is enlarged, the rotation of the shaft 10 may be stably supported.

Therefore, when the entire height of the shaft and the sleeve is reduced for the miniaturization and the thinning of the motor, the distance between the points at which the pressures generated by the upper and lower radial dynamic pressure parts are largest are shortened, such that the strength of the bearing may be degraded.

However, in the motor 100 according to the embodiment of the present invention, since the thickness of the base cover 50 may be reduced by controlling the intervals G1 and G2 in implementing the miniaturization and the thinning of the motor, the miniaturization and the thinning of the motor may be implemented without reducing the entire height of the shaft 10 and the sleeve 40.

Therefore, the motor 100 according to the embodiment of the present invention may allow the strength of the bearing to be maintained by maintaining the bearing span length S while being miniaturized and thinned.

The principle that the motor 100 according to an embodiment of the present invention is floated and rotated mat be associated with the pressure generated by the radial dynamic pressure part, and dynamic pressure and static pressure acting on the thrust plate 20.

That is, when an external power is applied to the coil 70 wound around the core 80 coupled to the base 60, the hub 30 may rotate by electromagnetic interaction between the coil 40 and the magnet 90 coupled to the hub 30, and the shaft 10 may also rotate together with the hub 30 by the rotation of the hub 30.

At this time, the oil O filled in the clearance between the shaft 10 and the sleeve 40 may be collected in the bent points X and Y by the radial dynamic pressure part 46 according to the rotation of the shaft 10 (See E, F, G, and H of FIG. 5), such that the maximum level of the radial dynamic pressures R1 and R2 may be obtained at the bent points X and Y.

Therefore, the rotation of the shaft 10 may be supported by the radial dynamic pressures R1 and R2 and may prevent the shaft 10 from rotating while being eccentric from the center thereof.

In addition, the upper and lower radial dynamic pressure parts 42 and 44 may be asymmetrical based on the bent points X and Y, and the following conditional expression may be satisfied based on the bent points X and Y.

A+C>B+D [Conditional Expression]

Therefore, due to the configuration of the upper and lower dynamic pressure parts 42 and 44 satisfying the above conditional expression, at the time of rotation of the shaft 10 and the hub 30, in addition to the radial dynamic pressures R1 and R2 directed in the inner diameter direction, pressure T1 directed downwardly in the axial direction by the oil O may be generated.

Here, the pressure T1 directed downwardly in the axial direction by the oil O may not be dispersed because a circulation hole is not formed in the sleeve 40, and may act equally on the upper and lower surfaces of the thrust plate 20.

Here, even though the same pressure may act on the upper and lower surfaces of the thrust plate 20, the shaft 10 is floated due to a difference in area between the upper and lower surfaces of the thrust plate 20.

That is, even though the same pressure may act on the upper and lower surfaces of the thrust plate 20 by the radial dynamic pressure part 46, force acting between the thrust plate 20 and the base cover 50 may be larger than force acting on the upper surface of the thrust plate 20, due to the difference in area therebetween, such that the shaft 10 may be floated.

Here, since a bottom surface of the thrust plate 20 and an upper surface of the base cover 50 may do not include a dynamic pressure part for generating dynamic pressure, the pressure acting between the bottom surface of the thrust plate 20 and the base cover 50 may be static pressure due to inflow of the oil O.

During continuous rotation of the rotating member including the shaft 10 and the hub 30 of the motor 100 according to the embodiment of the present invention, force by the static pressure due to the oil O flowing between the base cover 50 and the thrust plate 20 may be larger than force acting on the upper surface of the thrust plate 20, such that the shaft 10 may be continuously floated.

Here, since the shaft 10 needs to be floated while an optimized floating height thereof is maintained, after the shaft 10 is floated to have the optimized floating height, force offsetting the magnitude of the force by the static pressure between the base cover 50 and the thrust plate 20 may be required.

This force may be obtained by the thrust dynamic pressure part 48 formed in at least one of the upper surface of the thrust plate 20 and the bottom surface of the sleeve 40 facing the upper surface of the thrust plate 20.

That is, the thrust dynamic pressure part 48 may be formed as a groove having a herringbone shape, a spiral shape, and a screw shape to form the dynamic pressure (T2) directed in the inner diameter direction, that is, the thrust dynamic pressure, thereby offsetting the magnitude of the force by the static pressure between the thrust plate 20 and the base cover 50.

As a result, when the rotating member including the shaft 10 and the hub 30 may rotate in a normal state, the magnitude of the force acting on the upper surface of the thrust plate 20 and the magnitude of the force acting on the lower surface of the thrust plate 20 may be identical to each other. In other words, the pressure acting on the lower surface of the thrust plate 20 may be smaller than the pressure acting on the upper surface thereof.

Therefore, when the rotating member including the shaft 10 and the hub 30 of the motor 100 according to the embodiment of the present invention rotates while being floated to have a predetermined height, the force by the static pressure generated due to the oil O flowing between the bottom surface of the thrust plate 20 and the base cover 50 and the force acting on the upper surface of the thrust plate 20 may be in equilibrium with each other, to thereby allowing for securing of a stable floating height.

Here, the force acting on the upper surface of the thrust plate 20 indicates a difference between the force by the static pressure, which is the pressure of the oil O by the radial dynamic pressure part 46, and the force generated by the thrust dynamic pressure by the thrust dynamic pressure part 48.

In the case of the motor 100 according to the embodiment of the present invention, the occurrence of the contact between the thrust plate 20 and the base cover 50 caused by external impacts or the like may be prevented, and the miniaturization and the thinning of the motor may be implemented while the strength of the bearing is maintained.

As set forth above, with the motor according to the embodiments of the present invention, the contact between components due to the external impact or the like could be prevented, whereby the damage of the components could be prevented.

In addition, the strength of the bearing may be improved due to an increase in bearing span length, thereby allowing for maximization in rotational characteristics

While the present invention has been shown and described in connection with the embodiments, it will be apparent to those skilled in the art that modifications and variations can be made without departing from the spirit and scope of the invention as defined by the appended claims.

What is claimed is:

1. A motor comprising:
a sleeve supporting a shaft and a thrust plate coupled to the shaft through oil;
a hub operating together with the shaft and including a magnet coupled thereto;
a base including the sleeve and a core coupled thereto, the core including a coil wound therearound; and
a base cover coupled to the sleeve to thereby close a lower portion of the sleeve,
wherein an interval between the sleeve and the hub is smaller than an interval between the thrust plate and the base cover in order to maintain a state of non-contact between the thrust plate and the base cover.

2. The motor of claim 1, wherein the shaft and the hub rotate while being floated by the oil flowing between the thrust plate and the base cover.

3. The motor of claim 2, wherein pressure acting on a lower surface of the thrust plate is smaller than pressure acting on an upper surface thereof due to the oil.

4. The motor of claim 3, wherein at least one of the upper surface of the thrust plate and a surface of the sleeve corresponding to the upper surface of the thrust plate is provided with a thrust dynamic pressure part providing thrust dynamic pressure for preventing the shaft and the hub from being excessively floated.

5. The motor of claim 1, wherein the shaft and the thrust plate are formed integrally with each other.

6. The motor of claim 1, wherein an upper surface of the sleeve and the hub include an oil sealing part provided therebetween, the oil sealing part forming an interface of the oil.

7. The motor of claim 1, wherein at least one of an upper surface of the sleeve and a surface of the hub facing the upper surface of the sleeve is provided with a pumping part pumping the oil between the shaft and the sleeve.

8. The motor of claim 1, wherein an interval between an upper surface of the sleeve and the hub increases in an outer diameter direction.

9. The motor of claim 8, wherein the upper surface of the sleeve is inclined downwardly in the outer diameter direction.

10. The motor of claim 8, wherein a surface of the hub facing the upper surface of the sleeve is inclined upwardly in the outer diameter direction.
